(19) United States
(12) Patent Application Publication
(10) Pub. No.: US 2005/0193893 A1
(43) Pub. Date: Sep. 8, 2005

(54) Method and apparatus for the distribution of advertisements and other graphic displays

(76) Inventor: George L. Poston, Woodstock, GA (US)

Correspondence Address: STITES & HARBISON, PLLC, 400 W MARKET ST, SUITE 1800, LOUISVILLE, KY, 40202-3352, US

(21) Appl. No.: 10/792,478

(22) Filed: Mar. 3, 2004

(51) Int. Cl. A47J 9/00

(52) U.S. Cl. 99/342

(57) ABSTRACT

A method of distributing a graphic display including the steps of providing a device in a pre-assembly configuration; applying a graphic display to the device; providing the device to a distributor at a price below fair market value; converting the device to a post-assembly configuration capable of supporting consumable products and having at least one interior surface and at least one exterior surface, each of the surfaces configured to receive the graphic display; ensuring the graphic display is visible; placing consumable products on or in the device; and distributing the device with the consumable products to a user. A device for distributing a graphic display may be adapted to support consumable products and has at least one interior surface and at least one exterior surface, at least one surface configured to receive the graphic display.

### FIELD OF THE INVENTION

The present invention relates to a method and apparatus for displaying graphics, and more specifically, disposable devices for holding the consumable products of a user, wherein the devices predominantly display to the user the advertisements of others while the user consumes the products.

### BACKGROUND OF THE INVENTION

In the carry-out food and beverage industry, a distributor typically provides consumable products from a concession stand, a restaurant, a sidewalk vending stand, or other establishments to customers for consumption at an alternate location. When multiple products are purchased and must be transported, a complimentary carrying device is often provided by the distributor for the convenience of the customer or end-user.

Because the carrying device is typically provided to the consumer at no additional charge, the cost of the device is borne by the distributor who provides the carrying device. Regardless of how inexpensively such a carrying device may be purchased, the cost associated with the device increases the expense of conducting business for the distributor.

In the case of a distributor doing large volumes of business, thousands of carrying devices may be distributed to consumers within a short time span, consumers that are attractive targets for a variety of people or entities wishing to widely disseminate information. For example, a concession stand at a public venue distributes carrying devices to the many consumers attending events at that location. Many large arenas hold various types of events and, therefore, the consumers attending the events often fall into discrete demographics, making the individual groups attractive target audiences for advertisers. However, the present options for disseminating advertisements and other graphic displays to an attendee at an event do not efficiently or cost-effectively reach the attendees.

For example, in a large arena, a fixed advertisement such as a poster, wall-hanging, or sign is seen only by those who directly pass by and view it. The limited locations for optimal viewing of those fixed advertisements, namely, the location where all eyes tend to focus at least occasionally, including, the scoreboard, the playing field or court, the course or track, the goal or finish line, the stage or screen, and the fence or barrier typically dividing the spectators from the performance or participants, are available only to a limited number of advertisers at a premium cost.

The remaining options for optimal viewing of advertisements are even more limited and more expensive, including, a player's uniform, the body of a vehicle, the back page of a program, the back drop of a stage, a blimp flying overhead, an airplane pulling a banner, and presentations over electronic-visual display systems.

The problems associated with these known options for disseminating advertisements and other graphic displays are well documented. For example, limited space, escalating costs, the quasi-permanent and relatively inflexible nature of signage, and the inability to quickly change displays to remove the sponsors of the recent event in favor of the sponsors for the upcoming event, are all present-day difficulties of advertisers trying to address target markets.

Accordingly, there remains a need in the art for a method and device which satisfactorily addresses the needs of the cost-conscious distributor, the needs of the audience sensitive advertiser, and the needs of the event attending consumer.

### SUMMARY OF THE INVENTION

The present invention meets the above identified needs, and others, by providing a method and device for distributing graphic displays, including advertisements, to users of carry-out consumable products, such as food and beverages, by applying graphic displays to no cost or pre-paid devices used to transport and/or support the consumable products during use. In this regard the user, and others, remain the captive audience of the graphic display during the entire time that the products are being transported and/or consumed. The invention may be provided to distributors of consumable products at a cost below fair market value, including at no cost or with payment by the supplier, to provide an incentive for using the devices having graphic displays to the exclusion of other devices.

A first exemplary embodiment of the present invention is designed to hold consumable products so that they may be easily carried and stabilized while being consumed. For example, the device may be used to transport carry-out food and beverages from a concession stand, restaurant, or other establishment, and has multiple surfaces suitable for receiving a visible graphic display. This exemplary embodiment has two configurations: a pre-assembly configuration, which is convenient for compact storage, and a post-assembly configuration, which is suitable for holding consumable products. The post-assembly configuration of this exemplary embodiment includes a floor and four side walls, which define a volume. This exemplary embodiment also includes two interior walls, which are positioned such that the volume is subdivided into three voids. In this exemplary embodiment, two of the three voids are substantially enclosed by a covering, which defines at least one aperture adapted for receiving a beverage container. As such, in the exemplary embodiment, a food product may be held in one void while beverages maybe held in the substantially enclosed voids.

There are many alternate embodiments. By way of example and not limitation, a second alternate embodiment in its post-assembly configuration is cone shaped, including a single continuous wall defining a single void suitable for holding a consumable product such as popcorn, while a third alternate embodiment in its post-assembly configuration is a two-dimensional tray having a portion for supporting a food product and a portion defining an aperture for receiving a beverage container.

The various structural elements of the exemplary embodiments, including floors, walls, and coverings, provide multiple surfaces, each suitable for receiving a graphic display. Specifically, structural elements of the first exemplary embodiment provide a series of external and internal surfaces. For purposes of explanation and not limitation, the “internal” surfaces refer to those surfaces designed to face the consumable product, and the “external” surfaces refer to those surfaces designed to face away from the consumable product. Depending on the specific structure of the embodiment there may be any number of surfaces.

A second exemplary embodiment is substantially conical, including a continuous internal surface, designed to face the void holding a consumable product, e.g., popcorn, and a continuous external surface, designed to face away from the void holding the consumable product. In the third exemplary embodiment, the device is a two-dimensional tray having an internal top surface, designed to face the supported consumable product, and an external bottom surface, designed to face away from the consumable product.

Turning now to an embodiment of the method of the present invention, distributors of consumable products often provide complimentary carrying devices to consumers purchasing products. These consumers are often attractive targets for parties wishing to distribute graphic displays, such as advertisers. Thus, an exemplary method of the present invention includes distributing graphic displays, such as advertisements, on the carrying devices provided by distributors of consumable products. The devices with graphic displays are offered to the distributor at a cost below fair market value to create an incentive for the distributor to use the devices with the graphic displays to the exclusion of other carrying devices. Below fair market, for purposes of this description, includes the meanings 1) at no cost to the distributor, as well as 2) paying the distributor to use the invention taught herein.

Another exemplary embodiment of the method includes the following steps, which need not be performed in the following order: providing an embodiment of the invention in a pre-assembly configuration; applying a graphic display to the configuration; providing the configuration with the graphic display to a distributor at a cost below fair market value; converting the pre-assembly configuration to a post-assembly configuration having at least one interior surface, at least one exterior surface, and being capable of supporting consumable products; ensuring that the graphic display is visible; placing consumable products in the configuration; and distributing the configuration with the consumable products to a user.

It is contemplated that graphic displays may be applied to an embodiment at any time convenient to the manufacturer, supplier, or distributor. For example, the pre-assembly configuration may be fed through a printer which applies graphic displays to the device, while the graphic displays may be applied to the post-assembly configuration with adhesive-mounted applications, stamps, print-on demand technology, magnets, lasers, chemical or mechanical applications, holograms, and other known or foreseeable application, or visa versa.

It is additionally contemplated that the graphic displays may be chosen based on the customer/user likely to be purchasing/using consumable products at a particular event or time. For example, at sporting events, a teams' game schedule or scores may be provided. For another example, at a musical event, a listing of tour dates or a new album advertisement may be provided. For yet another example, at a convention, advertisements of sponsors of the convention may be provided. Indeed, because of the graphic display the embodiment may be retained by the user as a souvenir or memento.

It is also contemplated that the consumers attending an event may be further divided into subgroups, for the purpose of discrete and highly defined target marketing. For example, print-on-demand technology, including printers of all variations, permit a distributor, using the present invention, to apply a customized message on each embodiment depending upon the known characteristics or interest of each customer. By way of quick explanation and not limitation, an attendee of a sporting event wearing a certain team insignia approaches a food or beverage distributor and places an order for a consumable product. The distributor, noticing the team insignia on the customer's apparel, retrieves a blank embodiment of the present invention and then applies onto it the same team insignia as worn by the customer. The consumable product is then placed in the newly decorated embodiment and the entire assembly is then handed to the customer.

The embodiments of the present invention may be provided to the distributor in any configuration. Thereafter the final embodiment is distributed with the consumable products to the customer or user, who has the opportunity to view the graphic displays during the time that the products are being transported and/or consumed, and who may dispose of or keep the embodiment for future use.

### DESCRIPTION OF THE DRAWINGS

FIG. 1 is a perspective view of an embodiment of the present invention in a post-assembly configuration;

FIG. 2 is an alternate perspective view of the device of FIG. 1;

FIG. 3 is a plan view of the device of FIG. 1, shown in a pre-assembly configuration; and

FIG. 4 is a flow chart illustrating the steps involved in an exemplary method for the distribution of graphic displays.

### DETAILED DESCRIPTION OF THE INVENTION

The present invention is a method and device for distributing advertisements or other graphic displays to users of consumable products by applying the graphic displays to devices used to transport and/or support the consumable products. In one embodiment, carrying trays with advertisements referencing a third-party are provided to distributors of consumable products at a cost below fair market value, to provide an incentive for using the present invention to the exclusion of other carrying trays. When the distributors provide the carrying trays to their own customers, the customer and/or end-user comes into direct and prolonged contact with the advertisement. Before describing the method of the present invention in detail, the device of the present invention will be described.

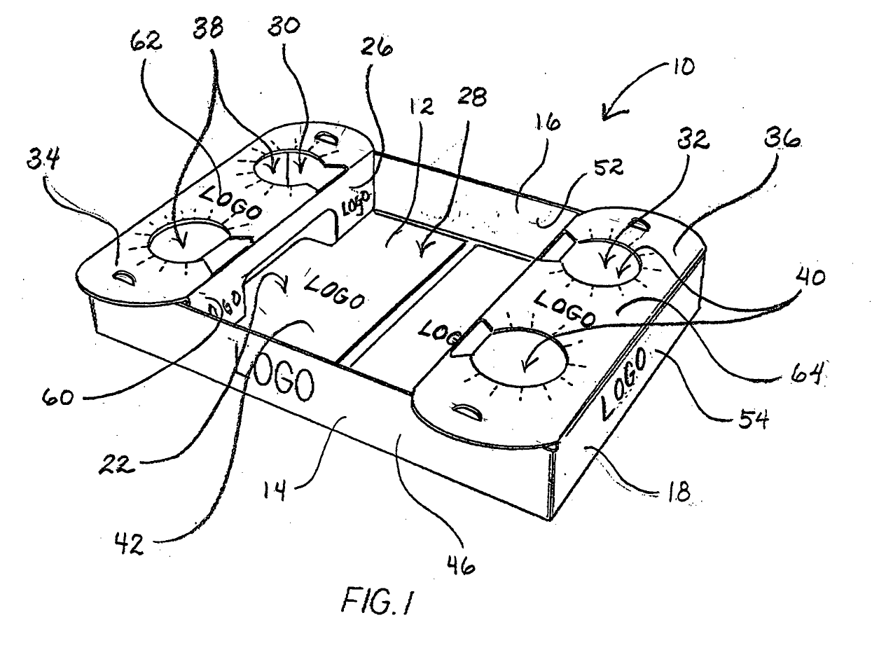

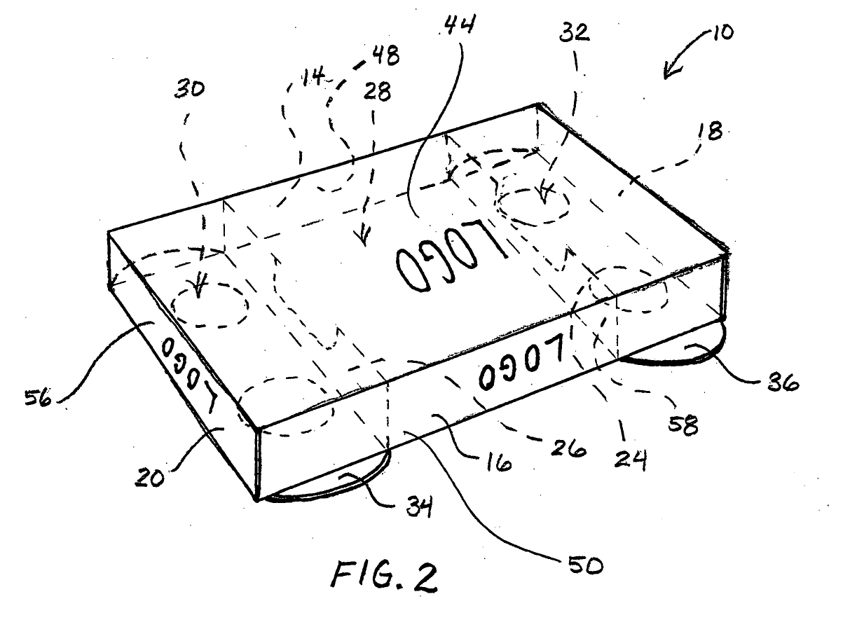

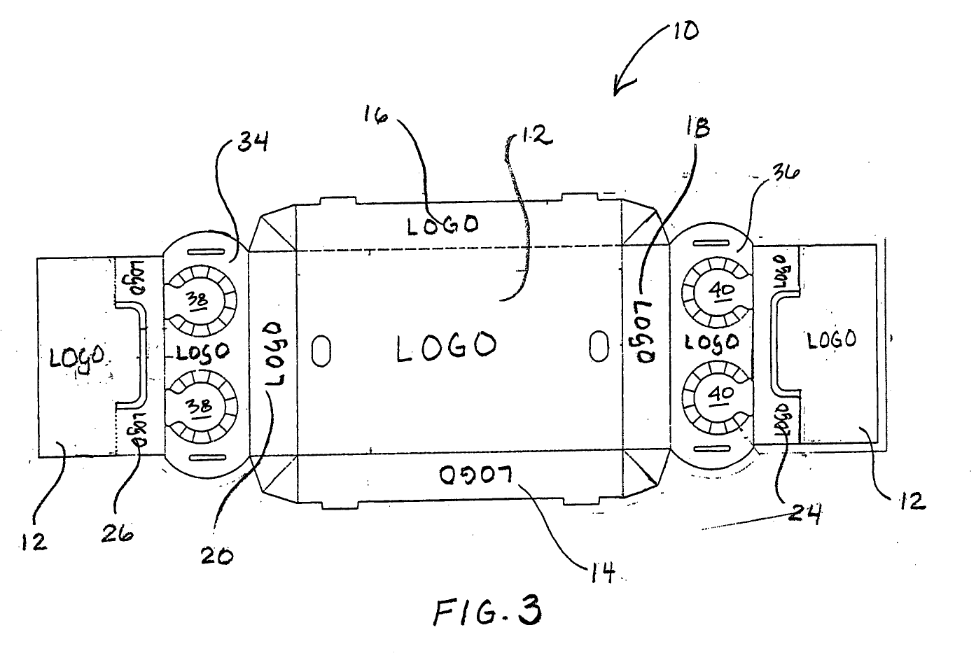

Referring now to the drawings, in which like numerals refer to like parts throughout the several views, an embodiment of the present invention has two configurations: a pre-assembly configuration and a post-assembly configuration. With reference to FIG. 3, the pre-assembly configuration of an embodiment of the device 10 is two-dimensional, allowing for compact storage of the device 10. Referring now to FIGS. 1 and 2, the post-assembly configuration of an embodiment 10 is three-dimensional. When in the post-assembly configuration, the device 10 is suitable for holding consumable products so that they may be easily carried and/or stabilized while being consumed.

The illustrated embodiment 10 includes a floor 12, a first side wall 14, a second side wall 16, a third side wall 18, and a fourth side wall 20. Each side wall 14, 16, 18, 20 extends upwardly from the floor 12, to define a volume 22. Additionally, the embodiment 10 includes a first interior wall 24 and a second interior wall 26 which extend upwardly from the floor 12 and between the first and second side walls 14, 16. The interior walls 24, 26 are positioned such that the volume 22 of the device 10 is subdivided into three voids 28, 30, 32. Specifically, the interior walls 24, 26 and the first and second side walls 14, 16 define a first void 28; the second interior wall 26 and the first, second and fourth side walls 14, 16, 20 respectively, define a second void 30; and the first interior wall 24 and the first, second and third side walls 14, 16, 18 define a third void 32.

Additionally, the second void 30 is substantially enclosed by a first covering 34, which abuts the tops of the walls 14, 16, 20, 26 and is spaced apart from the floor 12. Likewise, the third void 32 is substantially enclosed by a second covering 36, which abuts the walls 14, 16, 18, 24 and is spaced apart from the floor 12. The coverings 34, 36 each define at least one aperture 38, 40 adapted for receiving, in the illustrated embodiment, a portion of a beverage container. As such, food products may be held in the first void 28 while beverages maybe held in the second and third voids 30, 32.

In addition to the illustrated embodiment, there exists many alternate embodiments. By way of example and not limitation, one alternative embodiment comprises a two-dimensional pre-assembly configuration which may be rolled into a substantially conical post-assembly configuration, including a single continuous wall defining a single void suitable for holding a consumable product, such as popcorn. Another embodiment comprises a two-dimensional pre-assembly configuration, which may be converted to its post-assembly configuration by creating an aperture defined by the two-dimensional device. In this regard, one post-assembly configuration may be a two-dimensional tray having a portion for supporting a food product and a portion defining an aperture for receiving a beverage container.

In the post-assembly configuration the device 10 includes multiple surfaces, each suitable for receiving a visible graphic display. An embodiment of the present invention may be constructed from cardboard, paperboard, balsa wood, plastic, or any similarly stable and inexpensive material capable of receiving graphic displays. For strong and long-lasting embodiments, different materials or methods of manufacture may be selected, the selection being merely a design choice.

With reference to FIGS. 1 through 3, the illustrated embodiment 10 includes the floor 12, the coverings 34, 36, and the various walls 14, 16, 18, 20, 24, 26, each of which provide surfaces suitable for receiving a visible graphic display, as demonstrated and not limited by the word “LOGO” appearing on the device 10 in representative locations. It will be understood that the graphic display may be positioned anywhere on the device 10, the specific location being merely a design choice.

Regarding the structure of the illustrated embodiment, the floor 12 includes an interior horizontal surface 42 and an exterior horizontal surface 44. The first side wall 14 includes a first external vertical surface 46 and a first internal vertical surface 48. The second side wall 16 includes a second external vertical surface 50 and a second internal vertical surface 52. The third side wall 18 includes a third external vertical surface 54. The fourth side wall 20 includes a fourth external vertical surface 56. The first interior wall 24 includes a third internal vertical surface 58. The second interior wall 26 includes a fourth internal vertical surface 60. The first covering 34 includes a second exterior horizontal surface 62. In addition, the second covering 36 includes a third exterior horizontal surface 64. Any of these surface areas may be equally suitable for receiving a graphic display.

Of course, depending on the specific structure of the device, it could include any number of surfaces, and, in doing so, would not depart from the spirit and scope of the present invention. For purposes of explanation and not limitation, the “internal” surfaces refer to those surfaces designed to face the consumable product (not shown), and the “external” surfaces refer to those surfaces designed to face away from the consumable product. For example, a conical embodiment—having a single continuous internal surface designed to face a void holding a consumable product such as popcorn, and a single continuous external surface designed to face away from the void holding the consumable product—may include graphic displays on either or both surfaces. Likewise in a planer embodiment—having an internal top surface designed to face the consumable product that it will support, and an external bottom surface designed to face away from the consumable product—either surface may be suitable for receiving a graphic display.

It will be understood that each time the word “horizontal” and “vertical” and “upwardly” is used in this application, it is modified by the term “substantially” and used in relative relation to other elements of the invention.

Turning now to the method of the present invention, distributors of consumable products often provide complimentary carrying devices to their customers. Inexpensive, yet effective carrying devices are needed by distributors who seek to reduce operating expenses without sacrificing customer satisfaction. The purchasers and users of consumable products are often attractive targets for a variety of parties, including advertisers, wishing to widely distribute graphic displays. As such, the method of the present invention facilitates the distribution of graphic displays to customers, by placing graphic displays on the carrying devices provided by distributors of consumable products. The devices with graphic displays are supplied to the distributor at a cost below fair market value to create an incentive for the distributor to use the devices with the graphic displays to the exclusion of other carrying devices.

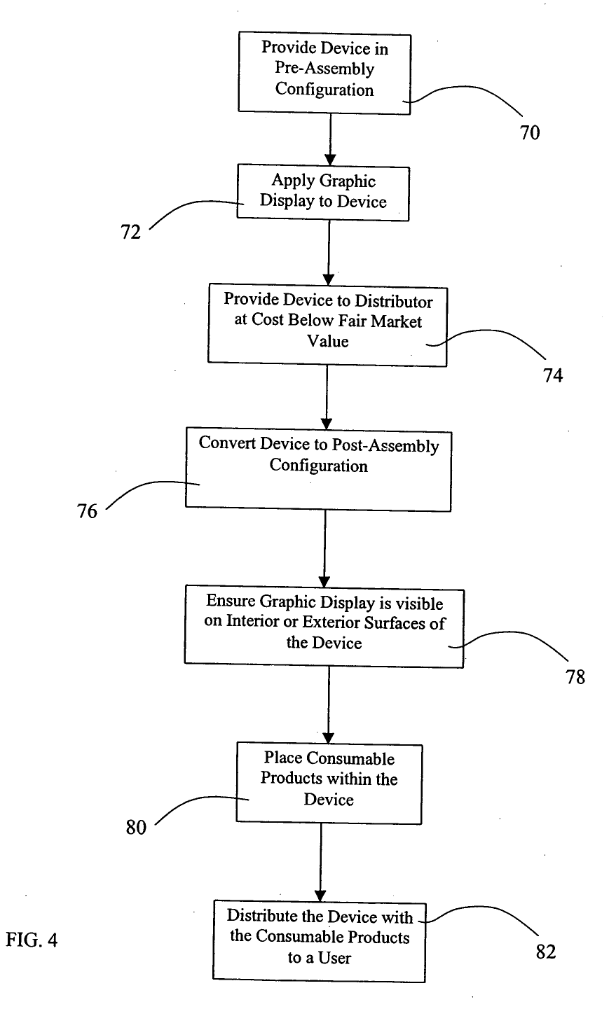

Referring now to the flow chart of FIG. 4, one embodiment of the method of the present invention generally includes the following steps, which need not be performed in a specific order: providing a device in a pre-assembly configuration 70; applying a graphic display to the device 72; supplying the device with the graphic display to a distributor at a cost below fair market value 74; converting the device from the pre-assembly configuration to a post-assembly configuration having at least one interior surface, at least one exterior surface, and being capable of supporting consumable products 76; ensuring that the graphic display is visible on interior or exterior surfaces of the device 78; placing consumable products in the device 80; and distributing the device with the consumable products to a user 82.

As shown in FIG. 4, this method embodiment begins at block 70 by providing an apparatus embodiment. For example, one embodiment is the pre-assembly configuration shown in FIG. 3. Of course, a contemplated equivalent step is to provide a post-assembly configuration and skip the conversion step described below at block 76.

At block 72, graphic displays are applied to the device. In FIGS. 1 through 3 the graphic displays are represented by the word “LOGO,” shown for the purpose of illustration and not limitation, in some of the many possible locations available on this embodiment. Although it is not necessary, it is contemplated that the graphic display be applied to the device while it is in the pre-assembly configuration. For example, the device may be fed through a printer, which applies graphic displays to one side or the other of the device in the pre-assembly configuration. Of course, the graphic display may be applied to pre-assembly or post-assembly configuration using known and foreseeable application methods including, print on demand, stamps, adhesives, laser, computer operated printers, heat transfers, chemical transfers, and mechanical attachment, as all are contemplated within the scope of the present invention.

It is also contemplated, but not required, that the graphic display applied to the device be specifically chosen and used during a particular event or at a particular time, based on the anticipated interests of the attendees likely to be purchasing consumable products at that event or time. In the case of multiple distributors at a large public venue, it is further contemplated that different graphic displays may be chosen for use at different areas within the same venue, based on the position of subgroups of attendees within the venue. For example, at sporting events a specific team's game schedule or scores may be provided to everyone or to just the fans of that team. For another example, at a musical event a listing of all musical engagements in the venue may be provided to everyone or a new album advertisement could be provided to the fans of a specific performer. For yet another example, at a convention, advertisements of sponsors of the convention could be provided. Further, it is contemplated that the graphic displays are unrelated to the supplier or distributor.

Referring still to FIG. 4, at block 74, the device is supplied to the distributor of consumable products at a cost below fair market value. In this regard, it is contemplated that the supplier of the device and the distributor enter into an agreement whereby the supplier agrees to provide devices at a particular cost below fair market value in exchange for the distributor's agreement to use the devices in the distribution of consumable products. Below fair market, for purposes of this description, includes both no cost to the distributor and paying the distributor to use an embodiment taught herein.

It is contemplated that the distributor may agree to use the devices provided by the supplier to the exclusion of other carrying trays. To facilitate such negotiations, the supplier may provide the device at no cost to the distributor or pay the distributor to use the device, enabling the distributor to completely eliminate a line item from its business expenses and providing the distributor with an incentive to enter into an exclusive agreement. It is contemplated that the device be provided to the distributor in the pre-assembly configuration, which includes a fully assembled and folded flat configuration to allow for compact storage. However the device may be provided to the distributor after it has been converted into the post-assembly configuration without departing from the spirit and scope of the present invention.

Eventually, the pre-assembly embodiment may be converted, at block 76, into the post-assembly configuration. For example, the device 10 in its two dimensional configuration shown in FIG. 3 may be folded into its post-assembly configuration shown in FIG. 1. In this regard it is contemplated that the pre-assembly configuration include fold lines and locking tabs to facilitate the rapid conversion from the fully-assembled but folded and stored flat configuration, to the unfolded post-assembly configuration shown in FIG. 1. Of course, alternative embodiments could be provided, which do not require folding or unfolding to complete the conversion. For example, the device in its pre-assembly configuration could comprise multiple discrete pieces which are connected together with locking tabs to complete the conversion. In another embodiment the device may be vacuum formed plastic produced in the post-assembly configuration.

At block 78, it is ensured that each graphic display is visible on a surface of the device. In this regard, as mentioned above, it is not important whether the graphic display is applied to the device in the pre-assembly or the post-assembly configuration, or to an interior or exterior wall. However the graphic display is typically, but not necessarily, applied to the device before the device is distributed to a user of consumable products. Further the graphic displays are typically, but not necessarily, visible on both internal and external surfaces. The graphic displays are considered visible on the interior surfaces of the device if they can be seen by the user either before or after the consumable products have been removed from the device.

At block 80 consumable products are placed within one or more voids of the device, so that multiple products may be easily transported, and, at block 82, the device containing the consumable products is distributed to the user, who is able to view the graphic display, as are others in her immediate vicinity. In this manner, wide distribution of a graphic display to a target audience is facilitated.

It will be obvious to those skilled in the art that further modifications may be made to the embodiments described herein without departing from the spirit and scope of the present invention.

1. A method of distributing a graphic display, comprising the steps of:
providing a device in a pre-assembly configuration;
applying a graphic display on said device;
providing said device to a distributor at a price below fair market value;
converting said device to a post-assembly configuration capable of supporting consumable products;
ensuring said graphic display is visible;
placing consumable products such that they are supported by said device; and
distributing said device with said consumable products to a user.

2. The method recited in claim 1, wherein said providing includes providing a device comprising at least one interior surface and at least one exterior surface.

3. The method recited in claim 2, wherein said providing includes providing at least one of said surfaces configured to receive said graphic display.

4. The method recited in claim 3, further comprising the step of positioning said graphic display so that it is constantly visible as said user consumes said products.

5. The method recited in claim 1, further comprising the step of entering into an agreement whereby a distributor agrees to exclusively use said device in conjunction with the distribution of said products.

6. A method of distributing a graphic display, comprising the steps of:
providing a two-dimensional device having a top surface and a bottom surface, either of said surfaces configured to receive said graphic display;
applying said graphic display to said device;
providing said device to a distributor at a price below fair market value;
placing consumable products such that they are supported by said device;
ensuring said graphic display is visible; and
distributing said device with said consumable products to a user.

7. The method of claim 6, further comprising the step of entering into an agreement whereby a distributor agrees to exclusively use said device in conjunction with the distribution of said products.

8. A method of providing advertising services, comprising the steps of:
negotiating an agreement with an advertiser to disseminate an advertisement on behalf of the advertiser;
providing a device including an interior and exterior surface capable of supporting consumable products, wherein either surface is configured to receive said advertisement;
applying said advertisement to at least one of said surfaces; and
negotiating an agreement with at least one distributor to provide the distributor with said device at a price below fair market value.

9. A device for displaying graphics, comprising:
a plurality of interior surfaces defining at least one void;
a plurality of exterior surfaces;
at least one of said surfaces configured to receive a graphic display;
a graphic display on at least one of said surfaces; and
said device supporting consumable products while said products are being consumed by a user.

10. A device for displaying graphics, comprising:
a floor defining an interior and an exterior surface;
at least one side wall extending upwardly from the floor and defining at least one interior and at least one exterior surface, said floor and said side wall defining a volume for receiving consumable products;
at least one interior wall defining a surface, extending upwardly from the floor and dividing said volume into at least two voids;
at least one covering defining a surface and including an aperture, substantially enclosing at least one of said voids; and
wherein any of said surfaces displays a graphic.

11. A device for displaying graphics, including:
a substantially horizontal internal surface;
a first external substantially vertical surface abutting at least one of said horizontal surfaces;
a second external substantially vertical surface abutting at least one of said horizontal surfaces;
a third external substantially vertical surface spaced between said first and second external substantially vertical surfaces abutting at least one of said horizontal surfaces;
a fourth external substantially vertical surface spaced between said first and second external substantially vertical surfaces abutting at least one of said horizontal surfaces;
an internal substantially vertical wall including a plurality of surfaces;
a substantially horizontal external surface defining an aperture, substantially parallel to and connectedly spaced apart from said horizontal internal surface by said internal wall;
wherein said surfaces connectedly define at least one void; and
at least one of said surfaces includes a visible graphic display.

12. A device for supporting consumable products, comprising:
at least one surface defining an aperture, said surface including an interior side and an exterior side;
said surface configured to receive a graphic display;
a graphic display on said surface; and
said device supporting consumable products while said products are consumed by a user.
